(19) United States
(12) Patent Application Publication
(10) Pub. No.: US 2024/0197558 A1
(43) Pub. Date: Jun. 20, 2024

(54) MASSAGE DEVICE

(71) Applicant: BODYFRIEND CO., LTD., Seoul (KR)

(72) Inventors: Myeong Jin YOU, Seoul (KR); Deok Hyun KONG, Seoul (KR)

(21) Appl. No.: 18/288,952

(22) PCT Filed: Apr. 28, 2022
(86) PCT No.: PCT/KR2022/006133

§ 371 Date: Oct. 30, 2023

(30) Foreign Application Priority Data
Apr. 30, 2021 (KR) 10-2021-0056442
Apr. 27, 2022 (KR) 10-2022-0052407

(51) Int. Cl. A61H 15/00; A47C 1/02; F16C 11/04

(52) U.S. Cl. CPC A61H 15/0078; A47C 1/02; F16C 11/04; A61H 2201/0149; A61H 2203/0431

(57) ABSTRACT

The present disclosure relates to a massage device including a seat frame supporting user's body, a back frame connected to the seat frame to be rotatable, a rail extending along the seat frame and the back frame and connecting the seat frame and the back frame to each other, and a support unit connected to the seat frame and the back frame and supporting the rail.

### TECHNICAL FIELD

The present disclosure relates to a massage device.

### BACKGROUND ART

Massage refers to a supplementary medical therapy for controlling modulation of a subject's body, helping blood circulation, and relieving fatigue by applying various types of mechanical stimulation to parts of the subject's body, such as kneading, pressing, pulling, tapping, or moving the part of the subject's body.

The increasing demands for massage have caused an increase in demands for massage devices or massage equipment that provides artificial massage functions due to economic and time reasons. That is, as the demands for relieving fatigue or stress by relaxing tense muscles through massage increase, various time and cost-efficient massage devices are being released.

Recently, people's interest in health has increased, and massage devices are changing from the devices simply providing massage functions to electronic devices that provide various additional functions and/or medical functions. Accordingly, researches on methods of effectively controlling massage devices are being continuously conducted.

Meanwhile, in a massage device of the related art, a position of headrest is fixed, and thus, inconvenience may occur because the position of the headrest does not correspond to the position of the head of a user who is being massaged. Accordingly, it is necessary to develop a massage device including a headrest that may be moved to correspond to the position of the user's head.

### DETAILED DESCRIPTION OF THE DISCLOSURE

### Technical Problem

The present disclosure provides a massage device having a compact structure of which an angle may be various adjusted and having improved durability due to a support structure therein.

However, the problem to be solved by the present disclosure is not limited to the problems described above, but includes problems that may be easily understood by those skilled in the art to which the present disclosure belongs from the present specification and attached drawings.

### Technical Solution to Problem

To achieve the above objective, an embodiment of the present disclosure provides a massage device including a seat frame supporting user's body, a back frame connected to the seat frame to be rotatable, a rail extending along the seat frame and the back frame and connecting the seat frame and the back frame to each other, and a support unit connected to the seat frame and the back frame and supporting the rail.

Also, the support unit may have one end connected to the seat frame to be rotatable and the other end connected to the back frame to be rotatable, and may support the rail of which the position is changed according to rotation of the back frame.

Also, the support unit may include a first link connected to the seat frame, a second link connected to the back frame, and a connection link connecting the first link and the second link to each other.

Also, at least one of the first link, the second link, and the connection link may have an elongated hole.

Also, the connection link may have a bent shape.

Also, the support unit may include guide roller which is installed on at least one of the first link and the second link and of which a position is adjusted along the rail.

Also, the guide roller may support the upper and lower surfaces of the rail.

Also, the massage device may include a reinforcing member that is attached to one side of the rail and has a shape changing along with the rail when the back frame is rotated.

Also, the rail may be more flexible than the reinforcing member.

Also, the rail may include a first region where the guide roller of the support unit contacts, and a second region arranged inside the first region and setting a moving path of the massage module.

Also, the massage device may further include a massage module of which the moving path is set by the rail and which is moved along the seat frame and the back frame.

Also, the massage module may include a driving roller moving along one surface of the rail, and a first support roller moving along the other surface of the rail.

Also, the massage device may further include a driving unit installed on one of the seat frame and the back frame and rotating the other.

### Advantageous Effects of Disclosure

A massage device according to an embodiment of the present disclosure may have various usage states. The massage device may be used in the form of a chair and a bed by adjusting an angle. Because a rail on which a massage module is moved may have deformable shape according to the usage state, the massage module may massage whole body of a user with a compact structure.

The massage device according to an embodiment of the present disclosure may have improved durability by reinforcing the rail having deformable shape. When the shape of the rail is deformed, a reinforcing member reinforces a strength of the rail and prevents damage to the rail.

The massage device according to an embodiment of the present disclosure has a support structure therein, and thus may support the rail having deformable shape and maintain various usages types. A support unit is installed at a portion where a seat frame and a back frame are connected and supports the portion where the seat frame and the back frame are connected when the back frame rotates depending on the usage condition, and thereby increasing the durability of the massage device.

However, the effects of the present disclosure are not limited above, but include effects that may be easily understood by those skilled in the art to which the present disclosure belongs from the present specification and attached drawings.

### BRIEF DESCRIPTION OF DRAWINGS

FIG. 1 is a diagram showing a massage device according to an embodiment of the present disclosure.

FIG. 2 is a diagram for describing components of the massage device of FIG. 1.

FIG. 3 is a perspective view showing part of a massage device according to the present disclosure.

FIG. 4 is a cut perspective view of the massage device of FIG. 3.

FIG. 5 is a diagram showing a massage module of FIG. 3.

FIG. 6 is a diagram showing an arrangement of the massage module on a rail of FIG. 3.

FIGS. 7 and 8 are diagrams showing a type in which the support unit of FIG. 3 supports the rail.

FIGS. 9 and 10 are diagrams showing the driving of a support unit according to a variation in a position of the rail.

### BEST MODE

A massage device including a seat frame supporting user's body; a back frame connected to the seat frame to be rotatable; a rail extending along the seat frame and the back frame and connecting the seat frame and the back frame to each other; and a support unit connected to the seat frame and the back frame and supporting the rail.

### Mode of Disclosure

The above objects, characteristics, and merits will become more apparent from the following detailed description taken in conjunction with the accompanying drawings. The following particular structure and functional descriptions are exemplified to describe an embodiment according to the concept of the present disclosure. Embodiments according to the concept of the present disclosure may be implemented in a variety of shapes and should not be construed as being limited to the embodiments described in the specification or application.

Since a variety of modifications may be made in the embodiments according to the concept of the present disclosure and the embodiments may have a variety of shapes, particular embodiments will be illustrated in the drawings and described in detail in the specification or application. However, these are not intended to limit the embodiments according to the concept of the present disclosure to a particularly disclosed form and it should be understood that the embodiments according to the concept of the present disclosure include all changes, equivalents, and substitutes included within the concept and technical scope of the present disclosure.

The terms such as first, second, and/or the like may be used to describe a variety of components, and the components should not be limited to the terms. The terms are used only for distinguishing one component from another. For example, a first component may be referred to as a second component, and similarly, the second component may be referred to as the first component without departing from the scope of the concept of the present disclosure.

When it is stated that one component is “connected” or “joined” to another component, it should be understood that the one component may be directly connected or joined to the other component but still another component may be present therebetween. On the other hand, when it is stated that one component is “directly connected” or “directly joined” to another component, it should be understood that still another component is not present therebetween. Other expressions for describing a relationship between components, that is, “between,” “directly between,” “adjacent to,” “directly adjacent to,” and the like should also be equally construed.

The terms used herein are used merely for describing particular embodiments and are not intended to limit the present disclosure. An expression used in the singular encompasses the expression of the plural, unless it has a clearly different meaning in the context. Throughout the specification, the terms “comprise,” “have,” or the like are used herein to specify the presence of implemented features, numbers, stages, operations, elements, components, or combinations thereof but do not preclude the presence or addition of one or more other features, numbers, stages, operations, elements, components, or combinations thereof.

Unless otherwise defined, all terms (including technical and scientific terms) used herein have the same meanings as commonly understood by one of ordinary skill in the art to which this invention belongs. The terms as defined in generally used dictionaries should be construed as having meanings which coincide with contextual meanings of related art and are not to be understood as ideal or excessively formal meanings unless clearly defined.

In the specification, an actuator means a component capable of providing a driving force. For example, the actuator may include an actuator, a linear actuator, an electronic actuator, a direct current (DC) actuator, an alternating current (AC) actuator, a linear actuator, an electric actuator, and the like but is not limited thereto.

In the present specification, a binaural beat may refer to audio information in a specific form capable of adjusting a brainwave.

In the present specification, according to an embodiment, a massage device may refer to a massage device including a body massage unit, an arm massage unit, and a leg massage unit. In addition, according to another embodiment, the body massage unit, the arm massage unit, and the leg massage unit may exist as separate devices (e.g., body massage device, arm massage device, and leg massage device), and the massage device may refer to the body massage device, the arm massage device, or the leg massage device.

Hereinafter, embodiments of the present disclosure will be described in detail with reference to accompanying drawings.

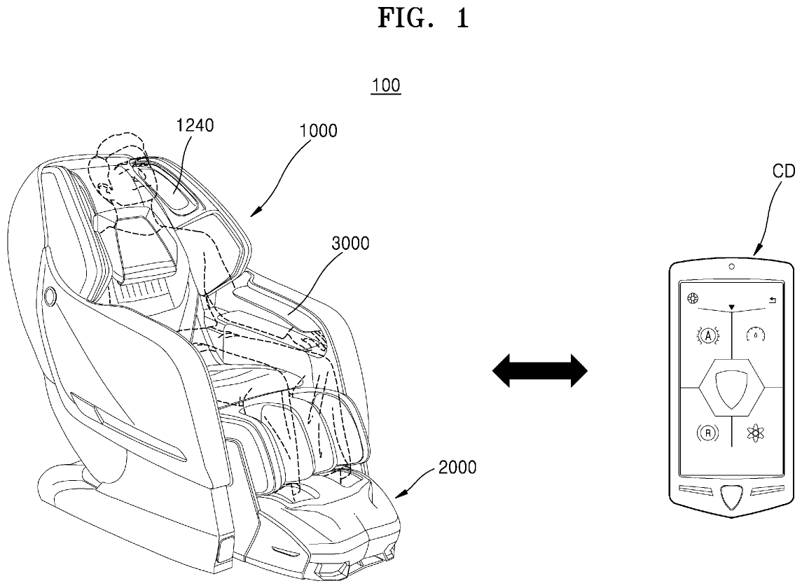

FIG. 1 is a diagram showing a massage device according to an embodiment of the present disclosure.

Referring to FIG. 1, a massage device 100 according to an embodiment of the present disclosure includes a body massage unit 1000 that forms an area for receiving at least a part of the user's body and massages the user's body, an arm massage unit 3000 massaging the arms of the user, and a leg massage unit 2000 massaging the legs of the user.

The body massage unit 1000 may provide massage to at least a part of the user's body. The body massage unit 1000 may include a massage module 1400 providing at least a part of user's body with a massaging function, an audio output module 1240 providing the user with an audio output of a certain form, a main frame 1100 forming a framework of the body massage unit 1000, and a user input unit 1230 for receiving an input of a certain form from the user.

The components included in the body massage unit 1000 described above are examples, and the body massage unit 1000 may include other various components in addition to the above components.

In addition, the shape and structure of the massage device 100 shown in FIG. 1 are merely examples, and without departing from the scope defined by the scope of the claims of the present disclosure, various types of the massage device 100 may also be included within the scope of the present disclosure.

The body massage unit 1000 may form a space of a certain shape for accommodating the user. The body massage unit 1000 may be provided with a space corresponding to a shape of the user's body. For example, as shown in FIG. 1, the body massage unit 1000 may be implemented as a seated type that may accommodate the user's entire body or partial body.

A portion in the body massage unit 1000, which comes into contact with the ground, may include a certain material or a certain member (e.g., anti-slippery pad, etc.) for increasing frictional force, and may include wheels for enhancing mobility of the massage device 100.

At least a part of the body massage unit 1000 may slidably move. For example, when the body massage unit 1000 starts a massage, at least a part of the body massage unit 1000 may slidably move forward. Also, the body massage unit 1000 may be tilted backward. As a result, the body massage unit 1000 may provide massage while tilted backward.

According to an embodiment of the present disclosure, the massage device 100 may include at least one air cell (not shown). The air cell may be located at the shoulder portion of the user, the pelvic portion, the arm massage unit, the leg massage unit 2000, etc., and is not limited thereto, that is, may be located at various portions of the massage device 100.

The massage device 100 may include an air supply unit (not shown), and the air supply unit may inflate the air cell by supplying air to the air cell. The air supply unit may be located inside the body massage unit 1000 and may be located in the leg massage unit 2000. Also, the air supply unit may be located outside the massage device 100.

The arm massage unit 3000 may provide arm massage to the user. For example, the arm massage unit 3000 may provide a massage to the user's arm, for example, the forearm muscle portion.

The leg massage unit 2000 may provide leg massage to the user. For example, the leg massage unit 2000 may include a calf massage unit that massages the user's calf and/or a foot massage unit that massages the user's feet.

The leg massage unit 2000 may have a length that is adjustable according to the user's body characteristics. For example, when a tall user uses the massage device 100, the length of the leg massage unit 2000 needs to be increased due to the long length of the calf. In addition, when a short user uses the massage device 100, the leg massage unit 2000 needs to be shortened due to the short length of the calf. Accordingly, the leg massage unit 2000 may provide a leg massage customized to the user's height.

The massage module 1400 may be provided in the body massage unit 1000 so as to provide a certain type of mechanical stimulation to the user accommodated in the body massage unit 1000. As shown in FIG. 1, the massage module 1400 may move along the main frame 1100 provided in the body massage unit 1000.

For example, the main frame 1100 of the body massage unit 1000 may be provided with a rack gear, and the massage module 1400 may provide the mechanical stimulation to various parts of the user's body while moving along the rack gear. The massage module 1400 may include, but is not limited to, a ball massage unit or a roller massage unit.

The main frame 1100 forms the framework of the internal structure of the body massage unit 1000 and may be formed of metal or plastic material. For example, the main frame 1100 may be formed of iron, alloy, steel, etc., but is not limited thereto, and may be formed of various hard materials.

According to an embodiment of the present disclosure, the massage device 100 may include the audio output module 1240. The audio output module 1240 may be provided at various locations. For example, the audio output module 1240 may include an upper audio output unit disposed on the upper end of a seat portion that is in contact with the user, front audio output units attached to front ends of the arm massage units on left and right sides of the seat portion, and/or rear audio output units attached to rear ends of the arm massage units, but is not limited thereto. In this case, the audio output module 1240 may provide three-dimensional sound such as 5.1-channel sound, but is not limited to this.

According to an embodiment of the present disclosure, the user may control the massage device 100 using a massage device control device CD. The massage device control device CD may be connected to the massage device 100 through wired communication and/or wireless communication.

The massage device control device CD may include, but is not limited to, a remote controller, a cellular phone, a personal digital assistant (PDA), etc., and may include various electronic devices that may be controlled through wired or wireless communication with the massage device 100.

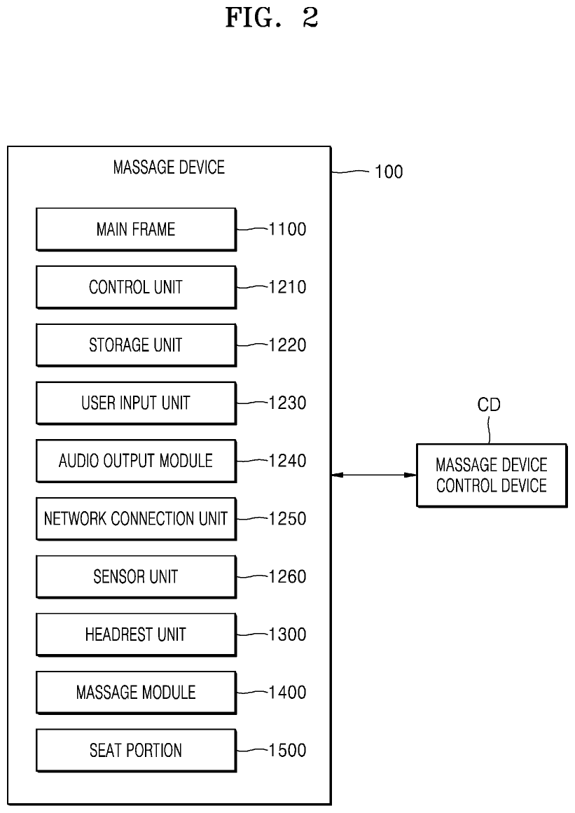

FIG. 2 is a diagram for describing components of the massage device of FIG. 1.

Referring to FIG. 2, according to an embodiment of the present disclosure, the massage device 100 may include at least one of the main frame 1100, a control unit 1210, a storage unit 1220, the user input unit 1230, and the audio output module 1240, a network connection unit 1250, and the massage module 1400.

The main frame 1100 may be a component that forms the framework of the body massage unit 1000.

According to an embodiment of the present disclosure, the main frame 1100 may include a seat frame and a back frame. The massage module 1400 may move along the main frame 1100. The massage module 1400 may move along the seat frame and the back frame. The seat frame and back frame are described in detail later.

The control unit 1210 may control the operations of the massage device 100. The control unit 1210 may be implemented with one processor or multiple processors. When the control unit 1210 is implemented with a plurality of processors, at least some of the plurality of processors may be located to be physically spaced apart from each other. Additionally, the control unit 1210 is not limited to the above example and may be implemented in various ways.

For example, the control unit 1210 may correspond to one or a plurality of processors. The processor may be implemented as an array of a plurality of logic gates, or as a combination of a universal microprocessor and a memory storing programs that may be executed in the microprocessor. In addition, one of ordinary skill in the art would appreciate that the central processor may be implemented as other types of hardware.

According to an embodiment of the present disclosure, the control unit 1210 may control the operation of the massage device 100. For example, the massage device 100 may include a plurality of actuators, and the massage device 100 may control the operation of the massage device 100 by controlling the operation of the plurality of actuators. For example, the massage device 100 may include at least one of a massage module moving actuator, at least one actuator included in the massage module 1400, a back angle actuator, a leg angle actuator, a foot massage actuator, a leg length adjustment actuator, and a sliding actuator, and the control unit 1210 may control the operations of the massage device 100 by controlling the actuators.

The massage module moving actuator is an actuator allowing the massage module 1400 to move up and down, and the massage module 1400 may move along the main frame 1100 by the operation of the massage module moving actuator.

The back angle actuator is an actuator that adjusts the angle of the part of the massage device 100 coming into contact with the user's back, and the back angle of the massage device 100 may be adjusted by the operation of the back angle actuator.

The leg angle actuator is an actuator that adjusts the angle of the leg massage unit 2000 of the massage device 100, and an angle between the leg massage unit 2000 and the body massage unit 1000 may be adjusted by the operation of the leg angle actuator.

The foot massage actuator refers to an actuator that operates the foot massage module included in the leg massage unit 2000. The massage device 100 may provide a foot massage to the user by using the foot massage actuator.

The massage module 1400 may include at least one actuator, and the control unit 1210 may provide various massage operations by operating at least one actuator. For example, the control unit 1210 may provide, but is not limited to, tapping massage, kneading massage, etc. by operating at least one actuator included in the massage module 1400, and may provide other various massage operations.

The leg length adjustment actuator refers to an actuator that adjusts the length of the leg massage unit 2000. For example, the control unit 1210 may adjust the length of the leg massage unit 2000 to be suitable for the user by using the leg length adjustment actuator, and accordingly, the user may be provided with the massage suitable for his/her body shape.

The sliding actuator enables sliding operation of the massage device 100. For example, the seat frame may move forward or backward by the operation of the sliding actuator, and as a result, the back frame connected to the seat frame may also move forward or backward.

The storage unit 1220 may store various information related to the massage device 100. For example, the storage unit 1220 may include massage control information and personal authentication information, but is not limited thereto.

The storage unit 1220 may be implemented through a non-volatile storage medium that may continuously store certain data. For example, the storage unit 1220 may include, but is not limited to, storage devices based on flash memory and/or battery-backup memory, as well as disks, optical disks, and magneto-optical storage devices.

Also, the storage unit 1220 may include a memory. The memory may denote, but is not limited to, a volatile storage device, which is a main storage device directly accessed by the processor and in which stored information is instantly erased when the power is turned off, such as random-access memory (RAM), e.g., dynamic random-access memory (DRAM), static random-access memory (SRAM), etc. The memory may be operated by the control unit 1210.

The user input unit 1230 may receive from the user commands related to operation control of the massage device 100, and the user input unit 1230 may be implemented in various forms. For example, the user input unit 1230 may be provided in the body massage unit 1000 or the leg massage unit 2000, but is not limited thereto.

The massage device 100 may obtain various commands from the user through the user input unit 1230. For example, the massage device 100 may include a certain command with respect to selection of a massage module, selection of a massage mode, selection of a massage intensity, selection of a massage time, selection of a massage area, selection of the position and operation of the body massage unit 1000, selection of turning/on-off of the massage device 100, selection as to operation of a heating function, selection as to sound source reproduction, etc., but is not limited thereto.

According to another embodiment of the present disclosure, the user input unit 1230 may be provided with buttons in the form of hot keys, and/or selection buttons for executing direction selection, cancellation, and input according to a preset user setting function or self-preset functions.

The user input unit 1230 may be implemented as a key pad, a dome switch, a touch pad (static pressure/electrostatic), a jog wheel, a jog switch, etc., but is not limited thereto. Also, the user input unit 1230 may obtain commands through the user's utterance based on voice recognition technology.

According to an embodiment of the present disclosure, the user input unit 1230 may include a display for displaying the operation status of the massage device 100 or the current status of the user. In this case, the display may include at least one selected from a liquid crystal display (LCD), a thin film transistor-liquid crystal display (TFT LCD), an organic light-emitting diode (OLED), a flexible display, and a 3D display, but is not limited thereto.

The audio output module 1240 may provide any type of audio output to the user. For example, the audio output module 1240 may provide the user with brain stimulation by outputting to the user sound sources and/or binaural beats optimized for the massage pattern provided by the massage device 100. The audio output module 1240 may output an audio signal received through a network (not shown) or stored in an internal/external storage medium (not shown). For example, the audio output module 1240 may output a sound source according to the control of a user terminal through a network connection (e.g., Bluetooth connection, etc.) with the user terminal. Also, the audio output module 1240 may output any type of acoustic signal generated in relation to the operation of the massage device 100.

The massage device 100 according to an embodiment of the present disclosure may include a network connection unit 1250. The network connection unit 1250 may perform communication with a module in the massage device 100, an external massage device, and/or the user terminal through any type of network. The network connection unit 1250 may include a wired/wireless connection module for network connection. As a wireless connection technology, for example, wireless LAN (WLAN), Wi-Fi, wireless broadband (Wibro), world interoperability for microwave access (Wimax), high speed downlink packet access (HSDPA), etc. may be used. As a wired connection technology, for example, digital subscriber line (XDSL), fibers to the home (FTTH), power line communication (PLC), etc. may be used. Additionally, the network connection unit 1250 may include a short-range communication module and may transmit and receive data with any device/terminal located in a short distance. Examples of the short-range communication technology may include Bluetooth, radio frequency identification (RFID), infrared data association (IrDA), ultra-wideband (UWB), ZigBee, etc., but are not limited thereto.

The massage device 100 according to an embodiment of the present disclosure may include a sensor unit 1260. Here, the sensor unit 1260 may include at least one sensor. For example, the sensor unit 1260 may include a pressure sensor, an infrared-ray sensor, an LED sensor, a photo sensor, a hall sensor, an electrostatic sensor, etc., but is not limited thereto.

The sensor unit 1260 may be used to obtain various information. For example, the sensor unit 1260 may be used to recognize the user. That is, information as to whether the user is seated, the body shape of the user, whether there is an abnormality in the user's body, etc. may be obtained. In another example, the sensor unit 1260 may be used to obtain biometric information. That is, fingerprint information, face information, voice information, iris information, weight information, electrocardiogram information, body composition information, etc. may be obtained, but the information is not limited thereto, and may include various biometric information.

According to another embodiment of the present disclosure, the massage device 100 may detect a contact area and/or contact position with the user via the sensor unit 1260. Also, the massage device 100 may obtain information about user's shoulder position via the sensor unit 1260. Also, the massage device 100 may provide customized massage based on the obtained information. For example, when the massage device 100 provides shoulder massage, the massage device 100 may recognize the position of the user's shoulder based on the information obtained through the sensor unit 1260 and provide shoulder massage to the user according to the recognition result.

The massage device 100 according to an embodiment of the present disclosure may include a headrest unit 1300. The headrest unit 1300 may support the user's head. For example, the headrest unit 1300 may be disposed at a position corresponding to the user's head when the user sits on the massage device 100, and may support the user's head.

In an embodiment, the headrest unit 1300 may be movable. For example, because the height and body shape of the users using the massage device 100 may vary, the headrest unit 1300 may be located at a position that does not correspond to the user's head and makes the user feel inconvenience when the headrest unit 1300 is fixed at one position. Therefore, the headrest unit 1300 may move to the position corresponding to the user's head and support the user's head.

The massage device 100 according to an embodiment of the present disclosure may include the massage module 1400. That is, the massage module 1400 is a component that provides mechanical stimulation to the user and may be moved along the main frame 1100.

The control unit 1210 may provide massage by controlling the operation of the massage module 1400 and applying mechanical stimulation to the user.

The control unit 1210 may move the massage module 1400 in X-axis, Y-axis, and Z-axis directions, etc. The control unit 1210 may make the massage ball move forward or retract backward on the X-axis, Y-axis, and Z-axis. Alternatively, the control unit 1210 may rotate the massage ball about the X-axis, Y-axis, and Z-axis.

The massage device 100 according to an embodiment of the present disclosure may include a seat portion 1500. The seat portion 1500 may cover at least a part of the main frame 1100.

In an embodiment, the seat portion 1500 may cover at least a part of the upper frame 1110. Accordingly, the impact applied to the main frame 1100 may be blocked by the seat portion 1500. Additionally, the exterior of the massage device 100 may be formed by the seat portion 1500.

In a specific embodiment, the seat portion 1500 covers a part of the back frame 130, which will be described later, and may be arranged to cover the rail 130 along the lengthwise direction of the user's body. Therefore, the seat portion 1500 may cover the movement path of the massage module 1400 and the movement path of the headrest unit 1300.

Referring back to FIG. 1, the leg massage unit 2000 may denote a component for massaging the user's legs. A leg accommodation space in which the user's leg is accommodated may be formed in the leg massage unit 2000.

The leg massage unit 2000 may include at least one of an air cell (not shown), a calf massage module (not shown), and a foot massage unit (not shown).

The air cell (not shown) may be a component for fixing at least a part of the user's body. The air cell included in the leg massage unit 2000 may be configured to receive air from an air supply unit that is separately provided and expand to secure at least part of the user's body.

The calf massage module (not shown) may be a component for massaging the calf portion of the user's leg accommodated therein. Here, the calf massage module may include a ball massage unit or a roller massage unit, as described above, but is not limited thereto.

The foot massage unit (not shown) may be a component for massaging the user's feet. The foot massage unit may include a foot massage module for massaging the user's feet. Here, the foot massage module may include a ball massage unit or a roller massage unit, but is not limited thereto.

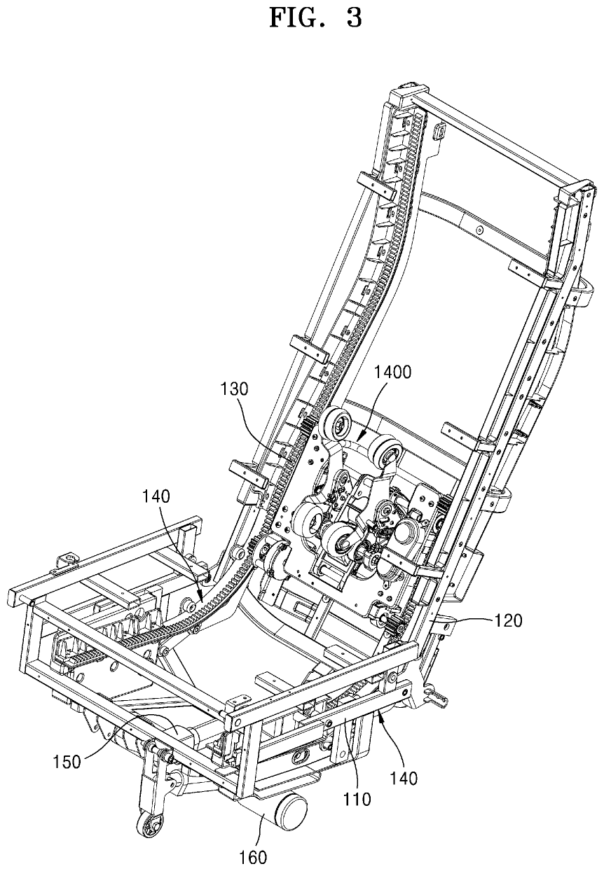

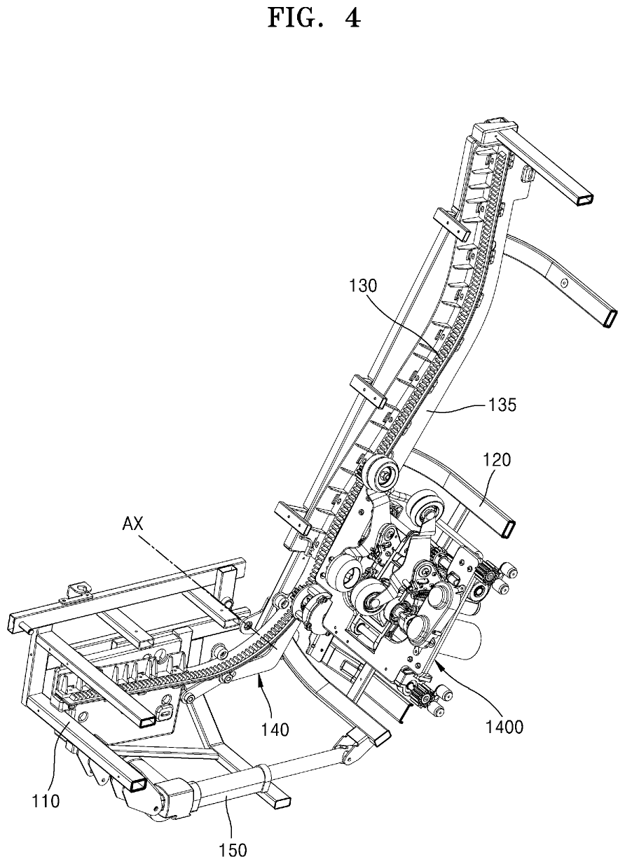

FIG. 3 is a perspective view showing a part of the massage device according to the present disclosure, and FIG. 4 is a cut perspective view of the massage device of FIG. 3.

Referring to FIGS. 3 and 4, the massage device 100 according to an embodiment may include the seat frame 110, the back frame 130, the rail 130, a reinforcing member 135, and a support unit 140. The seat frame 110 and the back frame 130 may be parts of the main frame 1100 described above. Also, in an alternative embodiment, the massage device 100 may further include a first driving unit 150 and a second driving unit 160.

The seat frame 110 may support the user's body. The seat frame 110 may form a seat on which the user sits when in use.

The seat frame 110 may be formed by assembling a plurality of frames to form a space where the user may sit on, and a device that generates a driving force may be installed on one side of the seat frame 110. For example, the first driving unit 150 and the second driving unit 160 may be disposed under the seat frame 110.

The back frame 130 may support the user's body. The back frame 130 may support the user's back when in use. The back frame 130 may be formed by assembling a plurality of frames to form a space in which the user's back is accommodated.

The back frame 130 and the seat frame 110 may be installed to be rotatable with respect to each other.

In an embodiment, the back frame 130 may be arranged to be rotatable with respect to the seat frame 110. In another embodiment, the seat frame 110 may be arranged to be rotatable with respect to the back frame 130. However, for convenience of explanation, the following description is provided based on an embodiment in which the back frame 130 rotates with respect to the seat frame 110 about a central axis AX.

When the first driving unit 150 is driven, the back frame 130 may be tilted with respect to the seat frame 110. When the first driving unit 150 is a cylinder device, the back frame 130 may rotate about the central axis AX due to the change in the length of the cylinder.

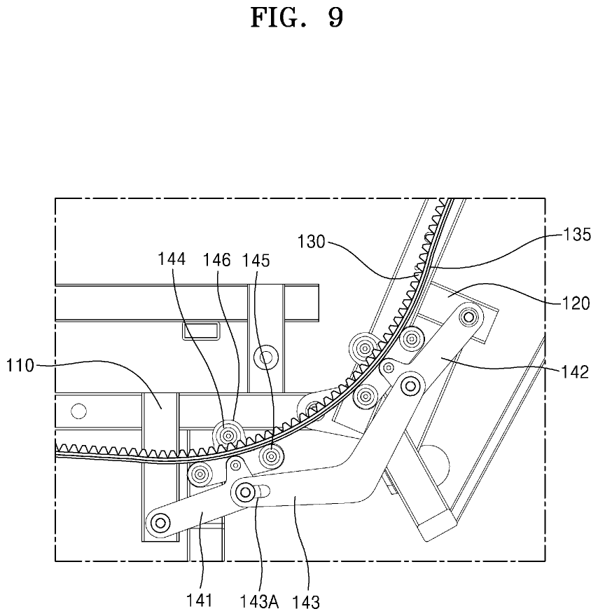

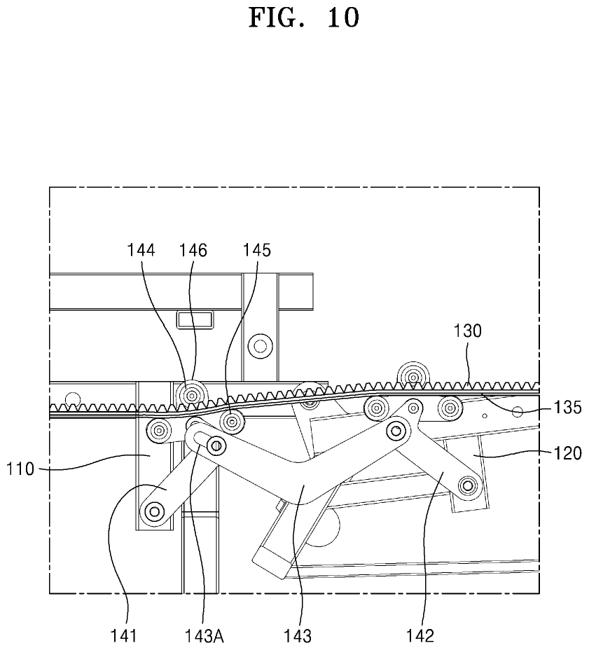

The massage device 100 may provide various ways of use to the user by adjusting the rotation angle of the back frame 130. The massage device 100 may be used in the form of a chair when the back frame 130 is inclined with respect to the seat frame 110 (see FIGS. 3 and 9). Additionally, the massage device 100 may be used in the form of a bed by forming the back frame 130 and the seat frame 110 side by side (see FIG. 10).

The rail 130 extends along the seat frame 110 and the back frame 130 and may connect the seat frame 110 to the back frame 130. The rail 130 may connect the seat frame 110 to the back frame 130 even when the back frame 130 rotates with respect to the seat frame 110. Therefore, the rail 130 according to the present disclosure allows the shape of the rail 130 to be changed at the portion where the seat frame 110 and the back frame 130 are connected to each other, when the massage device 100 is used in the form of a chair or bed.

The rail 130 may be provided as a pair arranged to face each other. One of the pair of rails may extend along one sides of the seat frame 110 and the back frame 130, and the other rail may extend along the other sides of the seat frame 110 and the back frame 130.

Because the rails 130 facing each other form a path through which the massage module 1400 may move, the massage module 1400 moving along the rails 130 moves to various positions in the seat frame 110 and the back frame 130 according to a manipulation of the user.

The rail 130 may be formed of a flexible material. The rail 130 may be formed of a material that may be deformed and restored to its original state to allow bending in a preset range. Even when the back frame 130 rotates about the central axis AX, the shape of the rail 130 may change in response to the tilting angle between the seat frame 110 and the back frame 130. That is, the portion of the rail 130, which is adjacent to the central axis AX, may be bent in a predetermined range according to the rotation of the back frame 130 or may be formed flat.

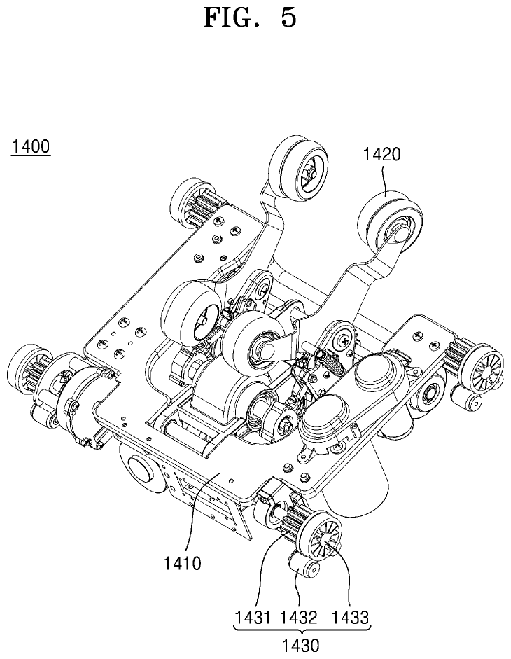

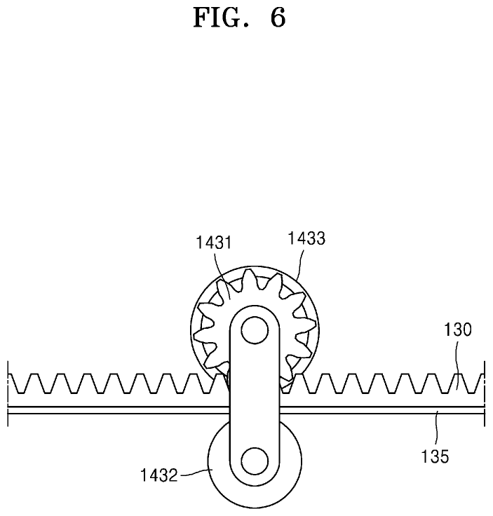

FIG. 5 is a diagram showing the massage module of FIG. 3, and FIG. 6 is a diagram showing the arrangement of the massage module on the rail of FIG. 3.

Referring to FIGS. 5 and 6, the massage module 1400 is installed on the rails 130 and may move along the rails 130.

The massage module 1400 may provide the massage to the user. For example, the massage module 1400 may provide tapping massage or kneading massage to the user's body.

The massage module 1400 has a movement path set by the rail 130 and may move along the seat frame 110 and the back frame 130.

In an embodiment, the massage module 1400 may be arranged in the body massage unit and may provide massage to the user while moving along the main frame 1100 arranged in the body massage unit.

In the massage module 1400 according to the present disclosure, the rail 130 is arranged to connect the seat frame 110 to the back frame 130, and thus, the movement range of the massage module 1400 may be expanded. That is, the massage module 1400 may massage the user's buttocks when driving in the seat frame 110 and may massage the user's back when driving in the back frame 130. In particular, one massage module 1400 may have a range of motion with respect to both the seat frame 110 and the back frame 130.

The massage module 1400 may include a module body 1410, a massage unit 1420, and a moving unit 1430.

The module body 1410, to which each of the components of the massage module 1400 is coupled, may form the overall shape of the massage module 1400. For example, the massage unit 1420 and the moving unit 1430 may be coupled to the module body 1410.

The massage unit 1420 may provide massage to the user's body. The massage unit 1420 may come into direct contact with the user's body, but may also come into indirect contact with the user's body with a separate component, such as a cover that covers the outside of the body massage unit, therebetween.

The massage unit 1420 may include, but is not limited to, a ball massage unit or a roller massage unit.

The moving unit 1430 may move the massage module 1400. The moving unit 1430 is dynamically connected to the rail 130 and may move along the rail 130. The moving units 1430 may be disposed on both sides of the module body 1410. In an embodiment, four moving units 1430 may be provided on the module body 1410.

In an embodiment, the moving unit 1430 may include a driving roller 1431 and a plurality of support rollers.

The driving roller 1431 may move along one surface of the rail 130. The driving roller 1431 may receive driving force from a massage module moving actuator (not shown). When the driving roller 1431 rotates, the massage module 1400 may move along a second region 132 of the rail 130.

The driving roller 1431 and rail 130 can be set as various mechanisms for transferring the driving force. Hereinafter, for convenience of description, an example of a rack and pinion structure in which the driving roller 1431 is engaged with the rail 130 and moving is performed along the teeth of the rail 130 due to the rotation of the driving roller 1431 is described.

In an embodiment, the driving roller 1431 may be a pinion gear having a plurality of teeth on the outer circumference thereof. The driving roller 1431 may be engaged with a second region 132 of the rail 130. The second region 132 of the rail 130 is formed of a rack gear and may extend along the length direction of the rail 130. When the driving roller 1431 rotates, the pinion gear moves along the rack gear, and thus, the massage module 1400 may move along the rail 130.

Because the support roller supports the rail 130, the support roller may allow the driving roller 1431 to be stably connected to the rail 130 when the driving roller 1431 rotates.

In an embodiment, a first support roller 1432 may move along the other surface of the rail 130. The first support roller 1432 is arranged opposite to the driving roller 1431 so that the rail 130 may be inserted into a gap between the driving roller 1431 and the first support roller 1432.

At least one first support roller 1432 may be provided. In an example, a first support roller 1432 may be provided to face the driving roller 1431. In another example, a plurality of first support rollers 1432 may be provided, and the driving roller 1431 may be disposed between the first support rollers 1432.

Referring to FIG. 6, the first support roller 1432 may support the reinforcing member 135. Because the reinforcing member 135 is installed on the other surface of the rail 130, the first support roller 1432 may support the reinforcing member 135.

In an embodiment, a second support roller 1433 may be arranged adjacent to the driving roller 1431. The second support roller 1433 may rotate about the same axis as the driving roller 1431. The second support roller 1433 may be disposed at an end portion of the driving roller 1431.

The second support roller 1433 may be supported on the first region 131 of the rail 130 so that the driving roller 1431 is stably engaged with the second region 132 of the rail 130. Because the second support roller 1433 is supported by the rail 130 on the outer portion of the driving roller 1431, the driving roller 1431 may be prevented from being escaped from the rail 130.

In an example, the moving unit 1430 may be driven by receiving power from a motor or an actuator that is separately provided. In this case, the control unit 1210 may provide power to the moving unit 1430 by controlling a motor or actuator, and accordingly, the massage module 1400 may provide massage to the user's body while moving.

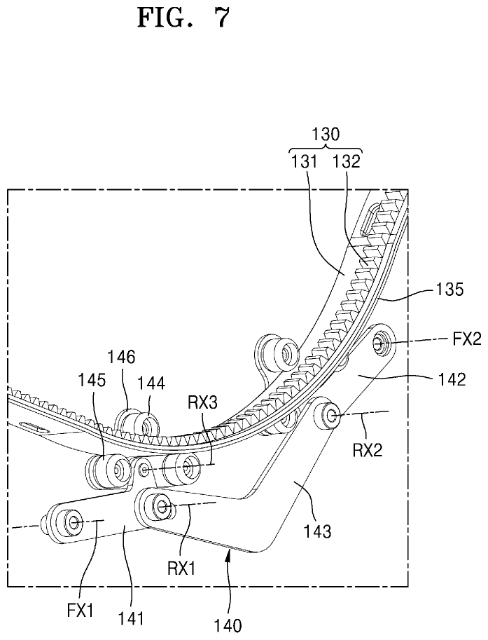

Referring to FIG. 7, the rail 130 may be divided into the first region 131 and the second region 132. A guide roller of the support unit 140 may come into contact with the first region 131. The second region 132 is disposed inside the first region 131 to set a movement path of the massage module 1400.

The first region 131 is set on the outer side of the rail 130 and may provide a space where the support unit 140 is installed. In an embodiment, the first region 131 may be set at a portion where the seat frame 110 and the back frame 130 are connected to each other and may provide a space where the support unit 140 is installed between the seat frame 110 and the back frame 130.

The second region 132 is set on the inner side the rail 130 and may provide a space where the driving roller 1431 of the massage module 1400 is installed. The second region 132 may be formed as a rack gear so that the driving roller 1431, which is a pinion gear, may be engaged. Because the second region 132 is set as the movement path through which the massage module 1400 moves, the second region 132 may extend throughout the seat frame 110 and the back frame 130.

Because the rail 130 is divided into the first region 131 and the second region 132, the massage module 1400 may move along the rail 130 without being interfered by the support unit 140. Because the support unit 140 is supported on the first region 131, the massage module 1400 moving along the second region 132 may be moved along the seat frame 110 and the back frame 130 without being interfered by the support unit 140.

Referring to FIG. 9, when the back frame 130 is arranged to have an inclination with respect to the seat frame 110, the support unit 140 supports the rail 130 on the first region 131 so that the massage device 100 may maintain the form of the chair, and because the massage module 1400 moves along the second region 132, the massage may be provided to the entire body of the user while the user is seated.

Referring to FIG. 10, when the back frame 130 is arranged in parallel to the seat frame 110, the support unit 140 supports the rail 130 on the first region 131 so that the massage device 100 may maintain the form of the bed, and because the massage module 1400 moves along the second region 132, the massage may be provided to the entire body of the user while the user is lying down.

The massage device 100 according to an embodiment of the present disclosure may further include the reinforcing member 135. The reinforcing member 135 is attached to the rail 130, and the shape thereof may change along with the rail 130.

Because the reinforcing member 135 reinforces the rail 130, durability may be maintained even when a high load is set on the rail 130. The reinforcing member 135 may prevent degradation of durability due to the shape deformation of the rail 130.

For example, the reinforcing member 135 may be attached to the lower surface of the rail 130 and may be a leaf spring. The reinforcing member 135 may come into contact with a second support roller 1433 of the moving unit 1430 that moves along the lower surface of the rail 130. Also, the reinforcing member 135 may come into contact with the guide roller of the support unit 140 that moves along the lower surface of the rail 130.

The reinforcing member 135 may have greater rigidity than the rail 130. When the massage device 100 is set in the shape of a chair, the rail 130 is bent by the movement of the back frame 130. The reinforcing member 135 may be bent along with the bent rail 130 to reinforce the rigidity of the rail 130. In addition, even when the rail 130 is repeatedly bent and restored to its original state due to the long-term use of the massage device 100, the reinforcing member 135 reinforces the rail 130 so that the durability of the rail 130 may not degrade.

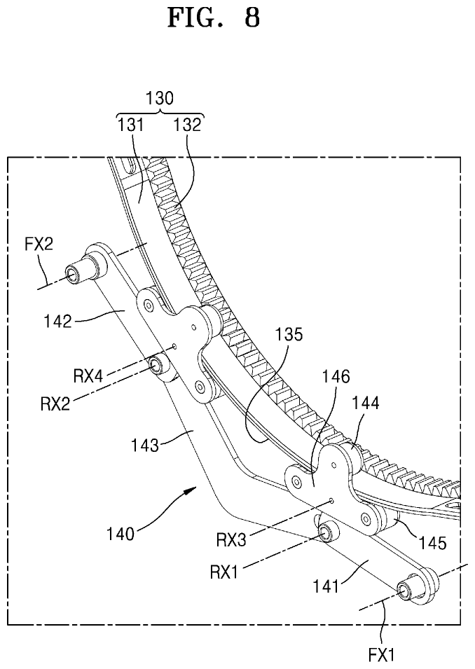

FIGS. 7 and 8 are diagrams showing a type in which the support unit of FIG. 3 supports the rail. FIG. 7 is a diagram seen from the inside of the massage device 100, and FIG. 8 is a diagram seen from the outside of the massage device 100.

Referring to FIGS. 7 and 8, the support unit 140 is arranged between the seat frame 110 and the back frame 130 and may support the rail 130. The support unit 140 is installed in a region where the shape of the rail 130 is deformed, and thus the massage device 100 may maintain the set arrangement or shape according to the setting from the user, at this time, damage to the rail 130 may be prevented.

The support unit 140 may be arranged adjacent to the central axis AX where the seat frame 110 and the back frame 130 are connected to each other. When the back frame 130 is set to have an inclination with respect to the seat frame 110, the support unit 140 may support one side of the rail 130 so that the rail 130 maintains the set inclination.

One end of the support unit 140 may be connected to the seat frame 110 to be rotatable and the other end of the support unit 140 may be connected to the back frame 130 to be rotatable. Thus, the position of the support unit 140 may be adjusted in response to a change in the position of the seat frame 110 or the back frame 130.

The guide roller of the support unit 140 comes into contact with the rail 130 and the position of the support unit 140 may be adjusted on the rail 130. As the position of the seat frame 110 or the back frame 130 changes, the position of the guide roller of the support unit 140 on the rail 130 may be adjusted.

In an embodiment, the support unit 140 may include a first link 141, a second link 142, a connection link 143, a first guide roller 144, a second guide roller 145, and a connector 146. The first guide roller 144 and the second guide roller 145 may be assembled in the connector 146, and the connector 146 may be installed on at least one of the first link 141 and the second link 142.

The first link 141 may be connected to the seat frame 110. The first link 141 may be connected to the seat frame 110 via a first connection axis FX1, and a position of the first link 141 may be adjusted according to the rotation of the seat frame 110 or the back frame 130. The first link 141 may be connected to the connection link 143 via the first rotation axis RX1 and may be connected to the connector 146 via a third rotation axis RX3.

The second link 142 may be connected to the back frame 130. The second link 142 may be connected to the back frame 130 via a second connection axis FX2, and a position thereof may be adjusted according to the rotation of the seat frame 110 or the back frame 130. The second link 142 may be connected to the connection link 143 via a second rotation axis RX2 and may be connected to the connector 146 via a fourth rotation axis RX4.

The connection link 143 may connect the first link 141 and the second link 142 to each other. The first link 141 and the second link 142 may be moved in conjunction with each other by the connection link 143.

In an embodiment, the connection link 143 may have a bent shape. The connection link 143 may have a portion connected to the first link 141 and a portion connected to the second link 142, which have a preset angle therebetween to roughly form a V-shape.

Because the connection link 143 has a bent shape, the rail 130 may be stably supported even with various types of using the massage device 100.

When the massage device 100 is used in the form of a chair (see FIG. 9), a part of the connection link 143 may extend along the seat frame 110 and the other part may extend along the back frame 130. Because the connection link 143 extends to correspond to the arrangement of the seat frame 110 and the back frame 130, the connection link 143 may stably support the seat frame 110 and the back frame 130.

When the massage device 100 is used in the form of a bed (see FIG. 10), both ends of the connection link 143 support the seat frame 110 and the back frame 130 and a center thereof is arranged on the lower portion. A center portion, which is thick, of the connection link 143 is arranged under the connection portion between the seat frame 110 and the back frame 130, and thus, the load may be distributed to the seat frame 110 and the back frame 130.

At least one of the first link 141, the second link 142, and the connection link 143 may have an elongated hole. The elongated hole may provide a space in which two connection links may linearly move.

In an embodiment, the elongated hole may be formed in one of the first link 141 and the connection link 143, so that the connection link 143 may be linearly moved while rotating with respect to the first link 141 when the back frame 130 is tilted.

In an embodiment, the elongated hole may be formed in one of the second link 142 and the connection link 143, so that the connection link 143 may be linearly moved while rotating with respect to the second link 142 when the back frame 130 is tilted.

For example, as shown in the drawings, the connection link 143 may have an elongated hole 143A in a portion connected to the first link 141. The position of the first rotation axis RX1 may be adjusted along the elongated hole 143A, by the elongated hole 143A.

The first guide roller 144 may support the upper side of the rail 130. The first guide roller 144 may be arranged to come into contact with the first region 131 of the rail 130. The first guide roller 144 is installed on each of the first link 141 and the second link 142 and may support and distribute the load transferred from the seat frame 110 and the back frame 130 to the rail 130.

The second guide roller 145 may support the lower side of the rail 130. The second guide roller 145 may be arranged to come into contact with the first region 131 of the rail 130. The second guide roller 145 is installed on each of the first link 141 and the second link 142 and may support and distribute the load transferred from the seat frame 110 and the back frame 130 to the rail 130.

The rail 130 may be inserted between the first guide roller 144 and the second guide roller 145 and may be supported by the first guide rail 130 and the second guide rail 130. The first link 141 and the second link 142 are rotated according to the rotation of the back frame 130, and the positions of the first guide roller 144 and the second guide roller 145 may be adjusted on the rail 130.

In an embodiment, the first guide roller 144 may be disposed between a pair of second guide rollers 145. When the massage device 100 is used in the form of a chair, the rail 130 is bent. The first guide roller 144 supports the upper side of the bent section, and the second guide roller 145 supports the lower side of the bent section, so that the bent state of the rail 130 may be firmly maintained.

The connector 146 may be connected to the first link 141 via the third rotation axis RX3 and connected to the second link 142 via the fourth rotation axis RX4. The connector 146 is provided with the first guide roller 144 and the second guide roller 145, and thus, the contact position of the first guide roller 144 and the second guide roller 145 onto the rail 130 may be adjusted in response to the change in positions of the first link 141 and the second link 142.

FIGS. 9 and 10 are diagrams showing the driving of a support unit according to a variation in the position of the rail.

Referring to FIG. 9, when the massage device 100 is set in the form of a chair, the support unit 140 may support the seat frame 110, the back frame 130, and the rail 130.

The support unit 140 is installed on the seat frame 110 and the back frame 130 to be rotatable, and the guide roller is supported by the rail 130. Because the guide roller supports the rail 130 in response to the tilting of the back frame 130, the support unit 140 may stably support the rail 130 and the reinforcing member 135.

The first link 141 is connected to the seat frame 110 to be rotatable, and a plurality of guide rollers may support the rail 130 that is adjacent to the seat frame 110 due to the connector 146 connected to the first link 141.

The second link 142 is connected to the back frame 130 to be rotatable, and a plurality of guide rollers may support the rail 130 that is adjacent to the back frame 130 due to the connector 146 connected to the second link 142.

The position of each guide roller installed on the first link 141 and the second link 142 is adjusted in response to the bending of the rail 130 and each guide roller supports the bent rail 130, and thus, the guide roller prevents damage to the rail 130 and may distribute the load applied to the rail 130. In addition, the connection link 143 connecting the first link 141 to the second link 142 is also arranged to correspond to the bent portion of the rail 130, and thus, the load applied to the rail 130 may be distributed.

Referring to FIG. 10, when the massage device 100 is set in the form of a bed, the support unit 140 may support the seat frame 110, the back frame 130, and the rail 130.

The support unit 140 is installed on the seat frame 110 and the back frame 130 to be rotatable, and the guide roller is supported on the rail 130. Thus, the guide roller of the support unit 140 may support the rail 130 in response to that the back frame 130 is arranged in parallel to the seat frame 110.

The position of each guide roller installed on the first link 141 and the second link 142 may be adjusted in response to the rail 130 deformed to be flat. Also, the guide roller supports the flat rail 130 to prevent damage to the rail 130 and to distribute the load applied to the rail 130. In addition, the connection link 143 connecting the first link 141 to the second link 142 is also arranged to correspond to the portion changed to be flat in the rail 130, and thus, the load applied to the rail 130 may be distributed.

Referring back to FIG. 3, the massage device 100 may include a driving unit. The driving unit may be an actuator.

The first driving unit 150 is attached to any one of the seat frame 110 and the back frame 130 and may provide the driving force so that the seat frame 110 or the back frame 130 may be tilted. For example, when the first driving unit 150 is a cylinder device, the seat frame 110 or the back frame 130 may rotate about the central axis AX by adjusting the length of the cylinder.

The second driving unit 160 is attached to the seat frame 110 and may adjust the rotation angle of the leg massage unit 2000. For example, when the second driving unit 160 is a cylinder device, the leg massage unit 2000 may be rotated with respect to the seat frame 110 by adjusting the length of the cylinder.

The massage device 100 according to an embodiment of the present disclosure may have various usage states. The massage device 100 may be set in both the chair type and the bed type, and because the rail on which the massage module is moved may have deformable shape according to the usage state, the massage module may massage the whole body of the user with a compact structure.

The massage device 100 according to an embodiment of the present disclosure may have improved durability by reinforcing the rail having deformable shape. When the shape of the rail is deformed depending on the usage state of the massage device, the reinforcing member reinforces the rigidity of the rail, and thereby preventing damage to the rail.

The massage device 100 according to an embodiment of the present disclosure has a support structure, and thus may support the rail having deformable shape and maintain various usages types. The support unit 140 is installed at a portion where the seat frame 110 and the back frame 130 are connected, and may support the portion where the seat frame 110 and the back frame 130 are connected to each other when the back frame 130 is rotated according to the usage state, and accordingly, the durability of the massage device 100 may be improved.

While the preferred embodiments of the present disclosure have been described in detail, it will be apparent to those skilled in the art that various modifications may be made to the above-described exemplary embodiments of the present disclosure without departing from the scope of the disclosure. Therefore, the embodiments of the disclosure are intended to illustrate and not limit the technical spirit of the disclosure, and the scope of the technical idea of the disclosure is not limited by these embodiments. Thus, the embodiment of the disclosure set forth herein or shown above are to be interpreted in an illustrative and non-limiting sense. The scope of which is to be interpreted by the following claims, and all technical ideas which are within the scope of the equivalence should be interpreted as being included in the scope of the right.

1. A massage device comprising:
a seat frame supporting user's body;
a back frame connected to the seat frame to be rotatable;
a rail extending along the seat frame and the back frame and connecting the seat frame and the back frame to each other; and
a support unit connected to the seat frame and the back frame and supporting the rail.

2. The massage device of claim 1, wherein
the support unit has one end connected to the seat frame to be rotatable and the other end connected to the back frame to be rotatable, and supports the rail of which the position is changed according to rotation of the back frame.

3. The massage device of claim 1, wherein
the support unit comprises:
a first link connected to the seat frame;
a second link connected to the back frame; and
a connection link connecting the first link and the second link to each other.

4. The massage device of claim 3, wherein
at least one of the first link, the second link, and the connection link has an elongated hole.

5. The massage device of claim 3, wherein
the connection link has a bent shape.

6. The massage device of claim 3, wherein
the support unit comprises a guide roller which is installed on at least one of the first link and the second link and of which a position is adjusted along the rail.

7. The massage device of claim 6, wherein
the guide roller supports an upper surface and a lower surface of the rail.

8. The massage device of claim 1, further comprising
a reinforcing member that is attached to one side of the rail and has a shape changing along with the rail when the back frame is rotated.

9. The massage device of claim 8, wherein
the rail is more flexible than the reinforcing member.

10. The massage device of claim 1, wherein
the rail comprises:
a first region where the guide roller of the support unit contacts; and
a second region arranged inside the first region and setting a moving path of the massage module.

11. The massage device of claim 1, further comprising
a massage module of which a moving path is set by the rail and which is moved along the seat frame and the back frame.

12. The massage device of claim 11, wherein
the massage module comprises:
a driving roller moving along one surface of the rail; and
a first support roller moving along the other surface of the rail.

13. The massage device of claim 1, further comprising a driving unit installed on one of the seat frame and the back frame and rotating the other.
